(19) United States
(12) Patent Application Publication
(10) Pub. No.: US 2020/0409344 A1
(43) Pub. Date: Dec. 31, 2020

(54) METHOD AND APPARATUS FOR RESOURCE PLANNING IN A FACTORY BASED ON A SIMULATION, AND COMPUTER READABLE RECORDING MEDIUM

(71) Applicant: VMS Solutions Co., Ltd., Yongin-si (KR)

(72) Inventors: Byung-Hee Kim, Yongin-si (KR); Soon-O Park, Yongin-si (KR); Goo-Hwan Chung, Yongin-si (KR); Seung-Young Chung, Suwon-si (KR)

(73) Assignee: VMS Solutions Co., Ltd., Yongin-si (KR)

(21) Appl. No.: 16/892,751

(22) Filed: Jun. 4, 2020

(30) Foreign Application Priority Data
Jun. 28, 2019 (KR) 10-2019-0077631

(51) Int. Cl. G05B 19/418

(52) U.S. Cl. CPC G05B 19/41865; G05B 2219/32359; G05B 2219/32365; G05B 19/41885

(57) ABSTRACT

Provided is a method for resource planning in a factory based on simulations. The method for resource planning may comprise: modeling factory resources as capacity buckets; allocating a plurality of demands to the modeled capacity buckets; and, constructing factory resource planning by performing capacity bucket simulations (CBSs) based on the factory resources to which the plurality of demands are allocated.

### CROSS REFERENCE TO RELATED APPLICATIONS

This application is based on and claims priority from Korean Patent Application No. 10-2019-0077631, filed on Jun. 28, 2019 with the Korean Intellectual Property Office, the disclosure of which is incorporated herein in its entirety by reference.

### FIELD OF THE DISCLOSURE

The present invention generally relates to a method and apparatus for resource planning in a factory based on simulations, and more particularly, to a method and apparatus for resource planning in a factory based on simulations that enable allocation of a plurality of demands to factory resources modeled as capacity buckets, and that enable factory resource planning on a per-machine basis within a BucketStep through a simulation that performs such demand allocation in a bucket rolling period for a predetermined time interval.

### BACKGROUND

Factories, for example, semiconductor fabrication plants (also referred to as “fabs” for short) are one of the most sophisticated man-made systems, and usually consist of hundreds or thousands of pieces of expensive equipment connected to automated resource handling systems. Constructing an optimal operation schedule in a factory (or a fab) comprising such a large number of pieces of equipment can greatly improve the productivity of the factory.

In order to meet all of a plurality of demands in a factory environment where a large number of resources (equipment, people, etc.) are provided, it is important to appropriately allocate the plurality of demands to limited resources.

However, since conventional factory resource scheduling methods (e.g., order-by-order, etc.) simply schedule a process in the backward direction according to the delivery deadline of a demand without a separate simulation process or simply adopt an approach that takes into account only the capacity of the entire process, not only is it difficult to reflect time-specific constraints of the resources, but also is there a limitation in efficiently allocating limited factory resources to meet all of a plurality of demands.

Therefore, there is an increasing demand in the art, in particular by the staff in charge of designing resources in a factory, for a new type of a method and apparatus for resource planning in a factory that make it possible to take into account time-specific constraints of the resources in modeling the factory resources as capacity buckets on a predetermined time basis and in performing a simulation for allocating a plurality of demands to such capacity buckets.

### SUMMARY OF THE INVENTION

The present invention is devised to solve the problems mentioned above, and it is an object of the present invention to provide a method and apparatus for resource planning in a factory based on simulations, capable of implementing efficient resource planning to meet a plurality of demands by utilizing limited resources in the factory.

In addition, it is another object of the present invention to provide a method and apparatus for resource planning in a factory based on simulations that make it possible to take into account time-specific constraints of resources and accordingly, to enable more efficient and accurate resource planning.

Furthermore, it is yet another object of the present invention to provide a method and apparatus for resource planning in a factory based on simulations that enable more efficient and accurate resource planning by constructing the resource planning at the levels of machines provided in a BucketStep of performing the same process.

Moreover, it is another object of the present invention to provide a method and apparatus for resource planning in a factory based on simulations that enable all the possible demands to be met more efficiently by constructing the resource planning based on the priorities for a plurality of demands and/or priorities for a plurality of machines in a BucketStep.

Furthermore, it is still yet another object of the present invention to provide a method and apparatus for resource planning in a factory based on simulations that make no demands left unmet and accordingly, that make it possible to maximize the operational efficiency of the factory and customer satisfaction, by allowing the priorities for a plurality of demands and/or priorities for a plurality of machines in a BucketStep to be variably adjusted according to a process or time.

The technical objects of the present invention are not limited to those mentioned above, and other technical objects that have not been mentioned will be clearly understood by those having ordinary skill in the art from the following descriptions.

In order to achieve the technical objects described above, a method for resource planning in a factory based on simulations in accordance with an embodiment of the present invention may comprise: modeling factory resources as capacity buckets; allocating a plurality of demands to the modeled capacity buckets; and, constructing factory resource planning by repeating the allocating in a bucket rolling period (BRP) for a predetermined time interval.

In addition, the factory resources may comprise a plurality of BucketSteps, each of which consists of a plurality of machines, and the modeling factory resources as capacity buckets may comprise modeling each of the plurality of machines as the capacity bucket.

Further, the allocating a plurality of demands to the modeled capacity buckets may comprise prioritizing the plurality of demands according to predetermined priority rules, and allocating the plurality of demands to the modeled capacity buckets based on the plurality of prioritized demands.

Moreover, the method may further comprise prioritizing the plurality of machines included in each BucketStep, and the allocating a plurality of demands to the modeled capacity buckets may comprise allocating the plurality of demands to the modeled capacity buckets based further on the plurality of prioritized machines.

Furthermore, the allocating a plurality of demands to the modeled capacity buckets may comprise: dividing each of the plurality of demands into one or more batches; and allocating the one or more divided batches to the modeled capacity buckets.

In addition, the bucket rolling period (BRP) may correspond to a time unit of the capacity bucket.

Further, the method may further comprise: determining whether there exist demands whose delivery deadline requirement is not met among the plurality of demands; if there exists at least one demand whose delivery deadline requirement is not met as a result of the determination, adjusting a priority for that demand; and allocating the plurality of demands based on new priority rules in which the adjusted priority is reflected.

Moreover, in order to achieve the technical objects described above, a simulation apparatus for constructing resource planning in a factory based on simulations in accordance with another embodiment of the present invention may comprise: a modeling unit for modeling factory resources as capacity buckets; a demand allocation unit for allocating a plurality of demands to the modeled capacity buckets; and, a control unit for constructing factory resource planning by repeating the allocating in a bucket rolling period (BRP) for a predetermined time interval.

Furthermore, in order to achieve the technical objects described above, a computer readable recording medium in accordance with a further embodiment of the present invention may have recorded thereon a program for performing the method for resource planning in a factory based on simulations.

According to the method and apparatus for resource planning in a factory based on simulations in accordance with an embodiment of the present invention, it is possible to implement efficient resource planning to meet a plurality of demands by utilizing limited resources in the factory.

In addition, according to the method and apparatus for resource planning in a factory based on simulations in accordance with an embodiment of the present invention, it is possible to take into account time-specific constraints of resources and accordingly, to enable more efficient and accurate resource planning.

Moreover, according to the method and apparatus for resource planning in a factory based on simulations in accordance with an embodiment of the present invention, it is possible to enable more efficient and accurate resource planning by constructing the resource planning at the levels of machines provided in a BucketStep of performing the same process.

Furthermore, according to the method and apparatus for resource planning in a factory based on simulations in accordance with an embodiment of the present invention, it is possible to enable all the possible demands to be met more efficiently by constructing the resource planning based on the priorities for a plurality of demands and/or priorities for a plurality of machines in a BucketStep.

Moreover, according to the method and apparatus for resource planning in a factory based on simulations in accordance with an embodiment of the present invention, it is possible to maximize the operational efficiency of the factory and customer satisfaction, by allowing the priorities for a plurality of demands and/or priorities for a plurality of machines in a BucketStep to be variably adjusted according to a process or time.

### BRIEF DESCRIPTION OF THE DRAWINGS

For a better understanding of the drawings discussed in the detailed description of the present invention, a brief description of each drawing is provided, in which:

FIG. 1A is a schematic diagram for describing a procedure of resource planning in a factory based on simulations in accordance with an embodiment of the present invention;

FIG. 1B is a conceptual diagram for describing a capacity bucket into which factory resources are modeled;

FIG. 1C is a conceptual diagram for describing the correlation between a demand and a batch;

FIGS. 2A to 2C are exemplary diagrams for describing a series of processes for establishing resource planning in a factory based on simulations in accordance with an embodiment of the present invention, for a plurality of BucketSteps in the factory and machines in each BucketStep;

FIG. 3 is a block diagram of a simulation apparatus 100 for constructing resource planning in a factory based on simulations in accordance with an embodiment of the present invention; and

FIG. 4 is a flow chart for describing a method for resource planning in a factory based on simulations in accordance with an embodiment of the present invention.

### DETAILED DESCRIPTION OF THE PREFERRED EMBODIMENTS

Hereinafter, embodiments in accordance with the present invention will now be described with reference to the accompanying drawings. It should be noted that in assigning reference numerals to components of each drawing, the same components are given the same reference numerals if possible, even when they are illustrated in different drawings. Furthermore, in describing embodiments of the present invention, if it is considered that detailed descriptions of related known configurations or functions get in the way of the understanding of the embodiments of the present invention, such detailed descriptions will be omitted. Moreover, hereinafter, embodiments of the present invention will be described; however, the spirit of the present invention is not limited or confined thereto, and may be modified and implemented in a variety of ways by those having ordinary skill in the art.

Throughout the specification, when a part is described to be “connected” to another part, this includes not only a case being “directly connected” but also a case being “indirectly connected” via another element therebetween. Throughout the specification, when a part is described to “include” a component, this does not mean to exclude other components but may further include other components unless described otherwise. In addition, terms such as a first, a second, A, B, (a), and (b) may be used in describing components of the embodiments of the present invention. These terms are only for distinguishing one component from another, and the nature, order, sequence, or the like of the components is not limited by such terms.

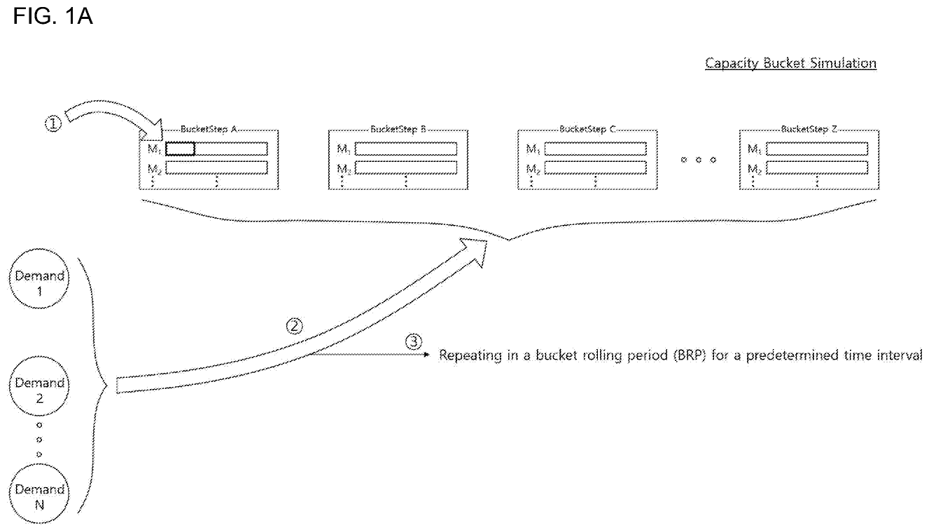

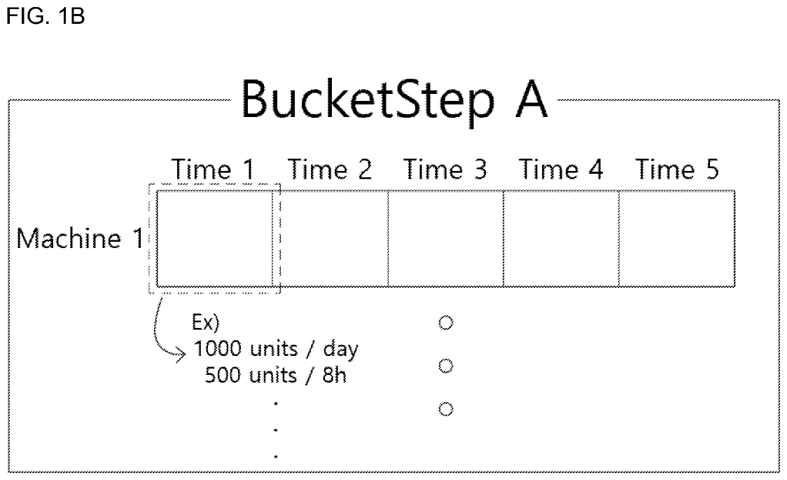

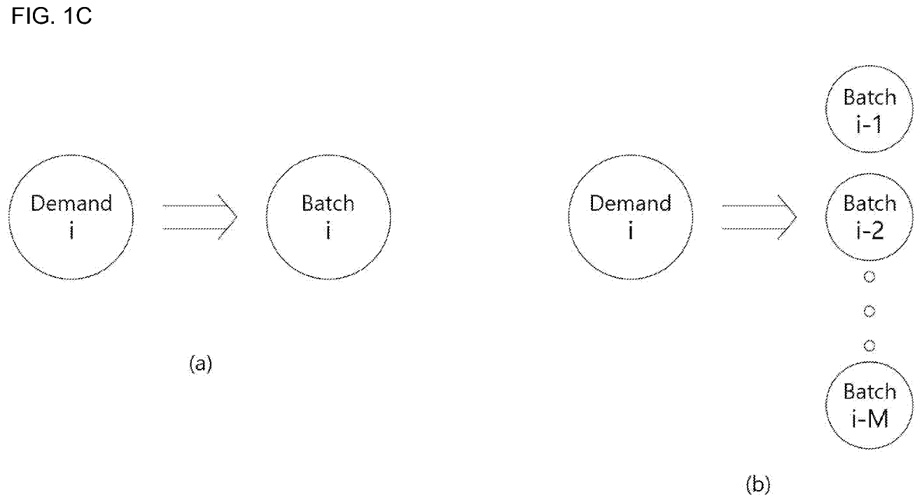

FIG. 1A is a schematic diagram for describing a procedure of resource planning in a factory based on simulations in accordance with an embodiment of the present invention, FIG. 1B is a conceptual diagram for describing a capacity bucket into which factory resources are modeled, and FIG. 1C is a conceptual diagram for describing the correlation between a demand and a batch.

First, in specifically describing a method and apparatus for resource planning in a factory based on simulations in the following description, relevant terms are defined as follows. A large number of pieces of equipment arranged in a factory are each configured to perform a specific process, and here, a group of pieces of equipment performing the same process is referred to as a BucketStep. For reference, the BucketStep may also be referred to as a station.

In addition, a plurality of pieces of equipment are included in each BucketStep, and a piece of equipment in the BucketStep that performs the same process as such is referred to as a machine. The plurality of machines in the BucketStep may all be configured to perform the same task, or alternatively, the plurality of machines in the BucketStep may be configured to perform the same process but different tasks (e.g., the same etching process, but different tasks of dry etching and wet etching). In particular, in the latter case, different capacity buckets may be modeled for each machine, which will be described in more detail below.

Further, resources such as equipment, people, and the like arranged in the factory are requested to manufacture not just one product but many types of products, and the delivery deadlines and quantities thereof, and so on are also different. Such requests from customers are referred to as demands, and the demand may include at least such information as an item (e.g., TV), a quantity (e.g., 1000 units), a delivery deadline (e.g., January 5), whether the delivery is allowed before the deadline (e.g., impossible), and a delivery destination (e.g., XX Electronics), and the like.

Referring to the conceptual diagram of FIG. 1A based on the conceptual definitions herein, a plurality of BucketSteps (BucketStep A, BucketStep B, , BucketStep Z) are arranged in the factory, each BucketStep is provided with a plurality of machines (M1, M2, . . . ), and resource planning based on simulations may be performed to meet a plurality of demands by utilizing such limited resources.

The resources in the factory may be modeled as a capacity bucket on a per-time basis, and the capacity bucket modeling is conceptually represented by ‘\textcircled{1}’ in FIG. 1A. The term ‘capacity bucket’ corresponds to a term that indicates the amount of work a particular machine can do over a certain period of time, and FIG. 1B corresponds to a conceptual diagram for describing the capacity buckets into which the factory resources are modeled.

For example, BucketStep A is provided with machine 1 in the example of FIG. 1B, and if BucketStep A is assumed to be a BucketStep for an etching process, then machine 1 may be modeled as the number of etchings capable of being carried out for a unit time (Time 1, Time 2, Time 3, Time 4, Time 5, etc.). For example, each machine in the BucketStep may be modeled as a capacity bucket of 1000 etchings/day, 500 etchings/8 hours, or the like. For reference, the time units of the modeled capacity buckets may be widely diverse (e.g., 4 h, 6 h, 12 h, 1 day, 2 days, 1 week, etc.), and ‘1 day’ will be described as an example for an easier understanding of the present invention in the following specification.

After modeling the factory resources as capacity buckets as conceptually represented by \textcircled{1} in FIG. 1A, a step of allocating a plurality of demands to the modeled capacity buckets may be performed, which is conceptually represented by ‘\textcircled{2}’ in FIG. 1A. Of course, it is possible to randomly allocate the plurality of demands to the factory resources modeled as the capacity buckets; however, there will be an order of tasks in the plurality of demands according to a delivery deadline, the level of importance, a delivery destination, etc., and accordingly, it would be more desirable to prioritize the plurality of demands based on predetermined priority rules and to allocate the demands starting with the one with a higher priority to the factory resources modeled as capacity buckets.

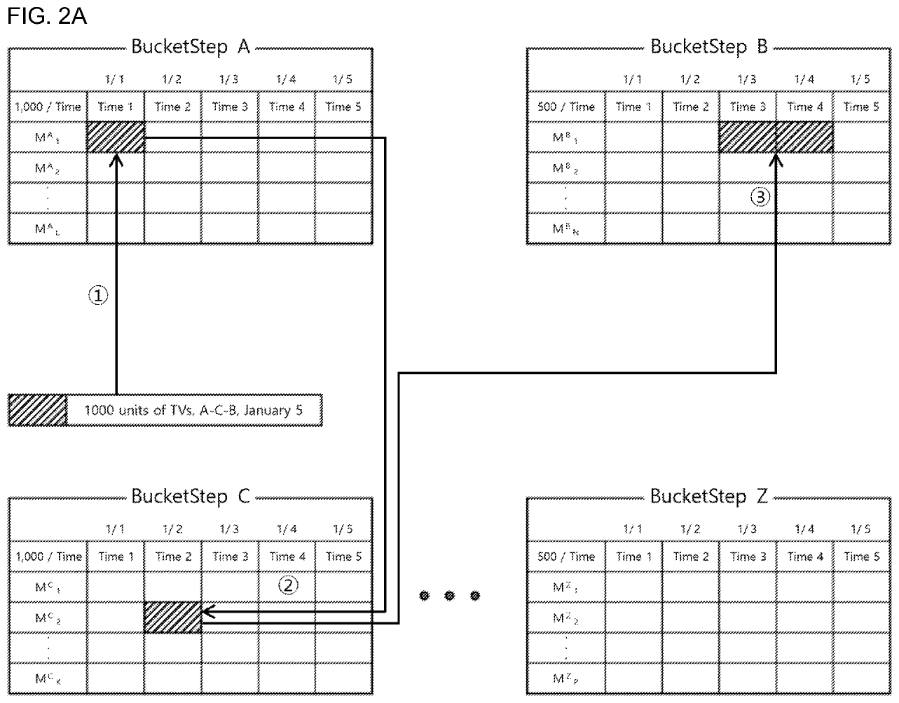

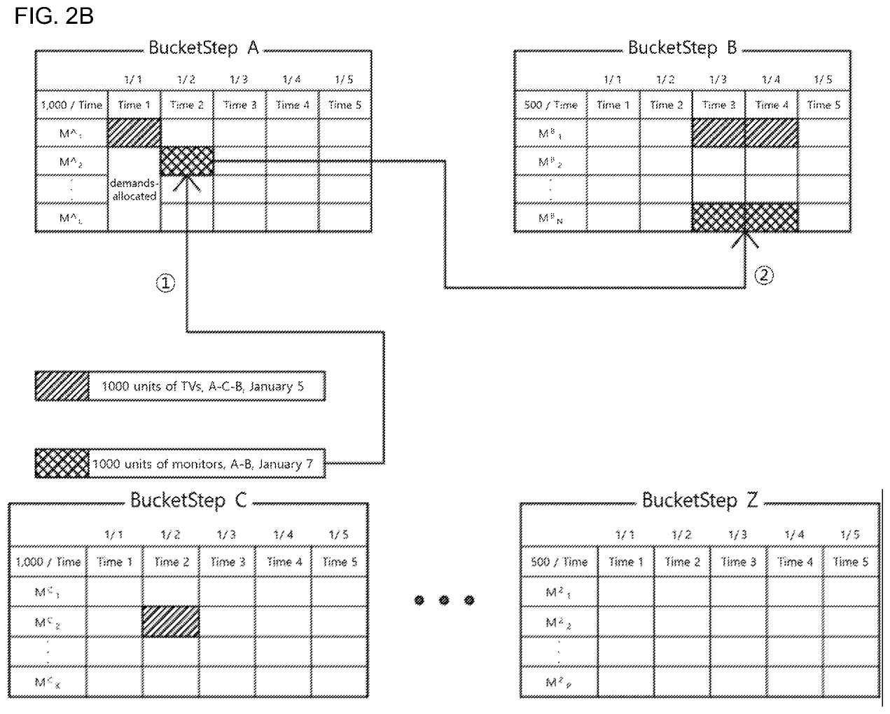

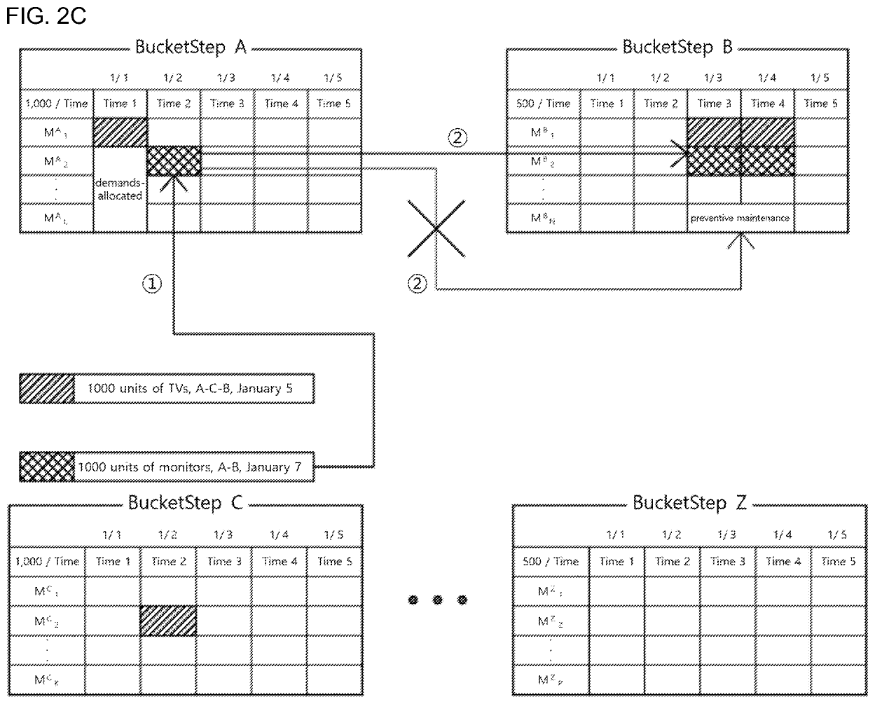

Here, the plurality of demands may be allocated as batches to the capacity buckets modeled, and FIG. 1C is a conceptual diagram for describing the correlation between a demand and a batch. The batch may also be referred to as a ‘workpiece’, a single demand may be considered as a single batch as shown in (a) of FIG. 1C or a single demand may be considered as a plurality of batches as shown in (b) of FIG. 1C, and in the latter case, a method for resource planning in a factory based on simulations in accordance with an embodiment of the present invention may further include: (i) dividing each of the plurality of demands into one or more batches; and (ii) allocating the one or more divided batches to the modeled capacity buckets. For reference, although FIG. 2, which will be set forth below, describes by way of example a configuration in which each demand is implemented as a single batch, it will be apparent that embodiments described below may also be equally applied to configurations in which each demand is implemented as a plurality of batches.

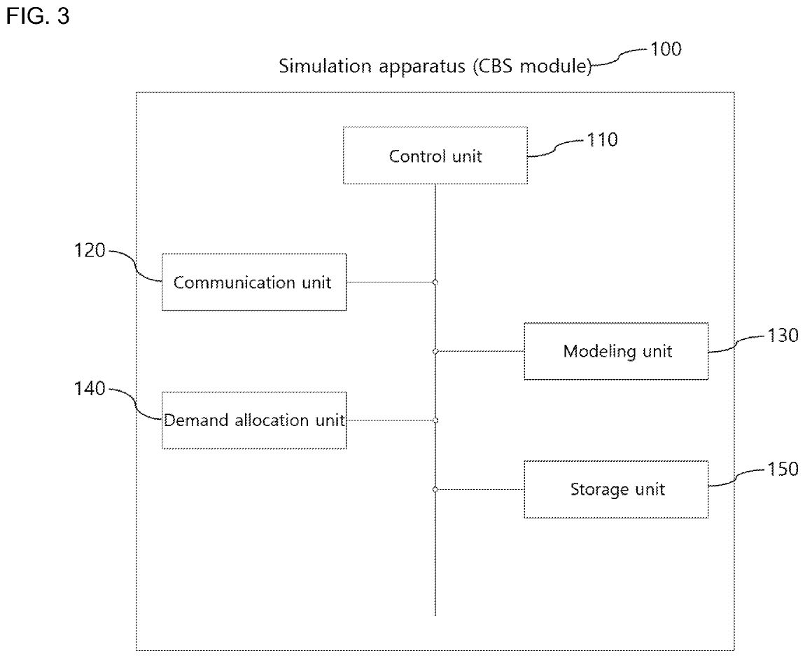

The process of modeling the factory resources as capacity buckets as represented by \textcircled{1} in FIG. 1A and the process of allocating the plurality of demands to the modeled capacity buckets as represented by \textcircled{2} in FIG. 1A correspond to a simulation process, and here, this simulation is performed based on the resources modeled as capacity buckets, and accordingly, is referred to as a capacity bucket simulation (CBS) herein below, and an apparatus for performing such a simulation is referred to as a simulation apparatus 100 (see FIG. 3 below), or simply a CBS module 100.

The simulation is performed in a bucket rolling period (BRP) for a predetermined time interval (e.g., 30 days, 60 days, etc.) as represented by ‘\textcircled{3}’ in FIG. 1A, and the BRP will be described as 1 day for an easy understanding of the present invention herein below. Thus, if the predetermined time interval is 30 days, the simulation process of \textcircled{1} and \textcircled{2} is performed 30 times in total every day (in a one-day interval), so that certain factory resource planning may be constructed \textcircled{3}.

For reference, the capacity bucket simulation (CBS) corresponds not to a simulation based on continuous events but to a simulation based on discrete events, and therefore, may be considered as part of a discrete event simulation (DES).

FIGS. 2A to 2C are exemplary diagrams for describing a series of processes for establishing resource planning in a factory based on simulations in accordance with an embodiment of the present invention, for a plurality of BucketSteps in the factory and machines in each BucketStep.

As conceptually described in FIG. 1a, the method for resource planning in a factory based on simulations in accordance with an embodiment of the present invention may involve: \textcircled{1} modeling factory resources as capacity buckets; \textcircled{2} allocating a plurality of demands to the modeled capacity buckets; and, \textcircled{3} constructing factory resource planning by repeating the demand allocation in a bucket rolling period (BRP) for a predetermined time interval. A series of processes constituting the method for resource planning in a factory based on simulations will be described in more detail by utilizing exemplary demands and exemplary factory resources in FIGS. 2A to 2C.

First, in allocating the plurality of demands to the modeled capacity buckets, the method for resource planning in a factory based on simulations in accordance with an embodiment of the present invention may prioritize the plurality of demands according to predetermined priority rules, and allocate the plurality of demands to the modeled capacity buckets based on the plurality of demands prioritized as such.

For an easier understanding of the present invention, a demand of “1000 units of TVs, A-C-B, January 5” is assumed to have the highest priority as of January 1 based on the predetermined priority rules among the pluralities of the demands in FIG. 2A. Here, the demand of “1000 units of TVs, A-C-B, January 5” means that 1000 units of TV products are to be manufactured by January 5 and for TV production, it is necessary to go through a process sequence of A-C-B in the factory. For reference, in addition to the information exemplified above, the demand may further include such information as whether the delivery is allowed before the deadline (e.g., impossible), a delivery destination (e.g., XX Electronics), and the like.

As shown in FIG. 2A, the TV-demand is first allocated to BucketStep A (represented by \textcircled{1} in FIG. 2A) because TVs need to go through process A first, and since the capacity bucket of BucketStep A is 1000 units/day, a period of 1 day is expected to take to carry out process A of the TV-demand in BucketStep A and therefore, the TV-demand may be allocated to any one of the plurality of machines (MA 1, MA 2, . . . , MA L) (where L is a natural number greater than or equal to 2) provided in BucketStep A to carry out process A of the TV-demand on January 1. Here, predetermined priority rules may be considered in selecting one of the plurality of machines belonging to the same BucketStep, and the priority rules here may be based on, for example, factory environments, constraints, qualities, setups, and the like. Here, the predetermined priorities may change over time, the method for resource planning in a factory based on simulations in accordance with an embodiment of the present invention may further reflect a change in priorities of demands and/or a change in priorities of machines according to changes in time when allocating the plurality of demands to the modeled capacity buckets, and accordingly, it is possible to fulfill the requirements of the plurality of demands more faithfully and completely.

Therefore, the method for resource planning in a factory based on simulations in accordance with a further embodiment of the present invention may further include prioritizing the plurality of machines included in each BucketStep, and the plurality of demands may be allocated to the modeled capacity buckets based further on the plurality of machines so prioritized.

Once process A for the 1000 units of TVs is completed, a demand allocation for process C to be subsequently carried out may be performed. The TV-demand is allocated to BucketStep C (indicated by \textcircled{2} in FIG. 2A) because process C needs to be subsequently performed, and since the capacity bucket of BucketStep C is 1000 units/day, a period of 1 day is expected to take to carry out process C of the TV-demand in BucketStep C and therefore, the TV-demand may be allocated to any one of the plurality of machines (MC 1, MC 2, . . . , MC K) (where K is a natural number greater than or equal to 2) provided in BucketStep C to carry out process C of the TV-demand on January 2. Likewise, predetermined priority rules may be considered here in selecting one of the plurality of machines belonging to the same BucketStep, and for example, the priority rules may be based on factory environments, constraints, qualities, setups, and the like.

Once process C for the 1000 units of TVs is completed, a demand allocation for process B to be subsequently carried out may be performed. The TV-demand is allocated to BucketStep B (indicated by \textcircled{3} in FIG. 2A) because process B needs to be subsequently performed, and since the capacity bucket of BucketStep B is 500 units/day, a period of two days is expected to take to carry out process B of the TV-demand in BucketStep B and therefore, the TV-demand may be allocated to any one of the plurality of machines (MB 1, MB 2, . . . , MB N) (where N is a natural number greater than or equal to 2) provided in BucketStep B to carry out process B of the TV-demand on January 3 and 4. Similarly, predetermined priority rules may be considered here in selecting one of the plurality of machines belonging to the same BucketStep, and for example, the priority rules may be based on factory environments, constraints, qualities, setups, and the like.

Through this procedure, the demand of “1000 units of TVs, A-C-B, January 5” having the highest priority as of January 1 may be allocated to the factory resources modeled as capacity buckets, and accordingly, it can be expected that the demand of “1000 units of TVs, A-C-B, January 5” will be completed on January 4, that is, the production will be completed normally before the delivery deadline (January 5).

Here, if the demand of “1000 units of TVs, A-C-B, January 5” falls into a demand that cannot be delivered before a deadline, for example, if a customer has requested the production of the 1000 units of TVs be completed exactly on January 5 due to the storage cost of the products, and the like, a demand allocation unit 140 in accordance with the present invention may adjust the delivery date for the demand of “1000 units of TVs, A-C-B, January 5” to January 5 by setting the priority of the demand of “1000 units of TVs, A-C-B, January 5” to be lower or setting a pause period of 1 day between the processes of A-C-B.

FIG. 2B schematically illustrates a process for allocating a demand of “1000 units of monitors, A-B, January 7” having the second-highest priority. The demand of “1000 units of monitors, A-B, January 7” means that 1000 units of monitors are to be manufactured by January 7, and for monitor production, it is necessary to go through a process sequence of A-B in the factory. For reference, in addition to the information exemplified above, the demand may further include such information as whether the delivery is allowed before the deadline (e.g., impossible), a delivery destination (e.g., XX Electronics), and the like.

As shown in FIG. 2B, the monitor-demand is first allocated to BucketStep A (indicated by \textcircled{1} in FIG. 2B) because monitors need to go through process A first, and since the capacity bucket of BucketStep A is 1000 units/day, a period of 1 day is expected to take to carry out process A of the monitor-demand in BucketStep A. Here, it is assumed that the demand allocation is completed for all the machines in BucketStep A by January 1.

Therefore, the TV-demand may be allocated to any one of the plurality of machines (MA 1, MA 2, . . . , MA L) (where L is a natural number greater than or equal to 2) provided in BucketStep A to carry out process A of the monitor-demand on January 2. Here, predetermined priority rules may be considered in selecting one of the plurality of machines belonging to the same BucketStep, and the priority rules here may be based on, for example, factory environments, constraints, qualities, setups, and the like. In particular, machine MA 1 may be set to have a very low priority in selecting a machine for carrying out process A of the monitor-demand in the example of FIG. 2B, because machine MA 1 is scheduled to carry out process A of the TV-demand on January 1 and accordingly, changing a product being manufactured from the TV to the monitor on the same machine, that is on the same line, may result in a setup. Thus, it is desirable to set the priorities of the plurality of machines in the BucketStep in a direction to minimize setups, and FIG. 2B shows an example in which the monitor-demand is allocated not to machine MA 1 but to machine MA 2.

Once process A for the 1000 units of monitors is completed, a demand allocation for process B to be subsequently carried out may be performed. The monitor-demand is allocated to BucketStep B (indicated by \textcircled{2} in FIG. 2B) because process B needs to be subsequently performed, and since the capacity bucket of BucketStep B is 500 units/day, a period of two days is expected to take to carry out process B of the monitor-demand in BucketStep B and therefore, the monitor-demand may be allocated to any one of the plurality of machines (MB 2, . . . , MB N) (where N is a natural number greater than or equal to 2) provided in BucketStep B to carry out process B of the monitor-demand on January 3 and 4, and the example in FIG. 2B shows an example allocated to machine MB N.

Through this procedure, the demand of “1000 units of monitors, A-B, January 7” having the second-highest priority as of January 1 may be allocated to the factory resources modeled as capacity buckets, and accordingly, it can be expected that the demand of “1000 units of monitors, A-B, January 7” will be completed on January 4, that is, the production will be completed normally before the delivery deadline (January 7).

Likewise, if the demand of “1000 units of monitors, A-B, January 7” falls into a demand that cannot be delivered before a deadline, the demand allocation unit 140 in accordance with the present invention may adjust the delivery date for the demand of “1000 units of monitors, A-B, January 7” to January 7 by setting the priority of the demand of “1000 units of monitors, A-B, January 7” to be even lower or setting a pause period of three days between the processes of A-B.

FIG. 2C corresponds to a conceptual diagram for describing an embodiment in which time-specific constraints of the resources are further considered in the course of allocating the demands illustrated in FIG. 2B.

The monitor-demand may be allocated to any one of the plurality of machines (MB 2, . . . , MB N) (where N is a natural number greater than or equal to 2) in BucketStep B to carry out process B of the demand of “1000 units of monitors, A-B, January 7,” and for machine MB N, preventive maintenance (PM) may be scheduled from January 3 to January 4. In this case, the demand allocation unit 140 of the simulation apparatus 100 (see FIG. 3) in accordance with an embodiment of the present invention may perform the demand allocation excluding machine MB N in selecting a machine within BucketStep B for process B of the demand of “1000 units of monitors, A-B, January 7.”

As described above, the method for resource planning in a factory based on simulations in accordance with an embodiment of the present invention may reflect or take into account the time-specific constraints of the resources at the levels of the machines, and accordingly, it is possible to fundamentally prevent the problem of pushing back an expected date of product completion due to the time-specific constraints such as preventative maintenance and the like and thus, of not meeting the delivery deadlines of customers, and such effects specific to the present invention is difficult to be accomplished by the conventional method that merely allocates resources in the backward direction by taking into account the capacity of the entire process only. As represented by \textcircled{2} in FIG. 2C, it can be confirmed that machine MB 2 has been selected instead of machine MB N for which preventive maintenance is scheduled for the corresponding period (January 3 to 4), so as to carry out process B of the demand of “1000 units of monitors, A-B, January 7.”

The procedure illustrated in FIGS. 2A to 2C describes a procedure of a simulation performed in a single bucket rolling period (BRP), and the method for resource planning in a factory based on simulations in accordance with an embodiment of the present invention can construct the factory resource planning by repeating such a simulation in the BRP, for example in a period of 1 day for a predetermined time interval (e.g., 30 days, 60 days, etc.).

For reference, the term ‘planning’ shall be defined herein as efficiently arranging the order of resources (e.g., equipment, etc.) in order to meet all of the plurality of demand, and may be used interchangeably with such terms as scheduling and sequencing, depending on implementations or embodiments.

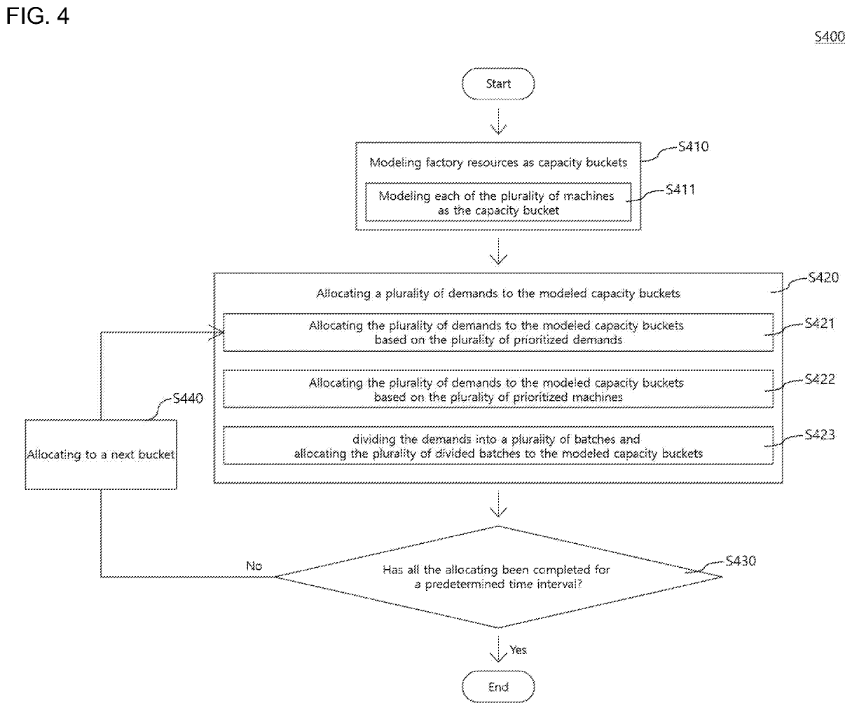

FIG. 3 is a block diagram of a simulation apparatus 100 based on simulations in accordance with an embodiment of the present invention, and FIG. 4 is a flow chart for describing a method for resource planning in a factory based on simulations in accordance with an embodiment of the present invention.

First, the simulation apparatus 100 in accordance with an embodiment of the present invention is configured to perform a series of processes of resource planning in a factory based on simulations described above, and may also be referred to as a CBS module for short as described above. As illustrated in FIG. 3, the simulation apparatus 100 in accordance with an embodiment of the present invention may include a control unit 110, a communication unit 120, a modeling unit 130, a demand allocation unit 140, a storage unit 150, and so on.

The control unit 110 is configured to generally control the operations, functions, tasks, etc. of the simulation apparatus 100 in accordance with the present invention, and may be implemented as a controller, a microcontroller, a processor, a microprocessor, or the like.

The modeling unit 130 may be configured to model factory resources as capacity buckets, the demand allocation unit 140 may be configured to allocate a plurality of demands to the modeled capacity buckets, and the control unit 110 may be configured to construct factory resource planning by repeating the demand allocation in a bucket rolling period (BRP) for a predetermined time interval.

The communication unit 120 is provided for a direct connection with the outside or a connection through a network, and may be a wired and/or wireless communication unit 120. More specifically, the communication unit 120 may transmit data from the control unit 110, storage unit 150, and the like by wire or wirelessly, or receive data from the outside by wire or wirelessly so as to transmit the data to the control unit 110 or to store in the storage unit 150. The data may include contents such as text, images, and videos, and user images.

The communication unit 120 may communicate through a local area network (LAN), Wideband Code Division Multiple Access (WCDMA), Long Term Evolution (LTE), Wireless Broadband Internet (WiBro), Radio Frequency (RF) communication, Wireless LAN, Wi-Fi (Wireless Fidelity), Near Field Communication (NFC), Bluetooth, infrared communication, and so on. However, these are merely exemplary, and various wired and wireless communication technologies applicable in the art may be used according to the embodiments to which the present invention is applied.

The storage unit 150 may have stored therein various data regarding the operations, functions, tasks, and the like of the simulation apparatus 100. For example, the data stored in the storage unit 150 may include the information on the factory resources, information on the capacity buckets, information on the bucket rolling periods (BRPs), information on the plurality of demands, information on the priorities of the demands, information on the priorities of the machines, information on the time constraint(s) of the resources, information on the demand-batch, information on the simulations, and the like.

For reference, the storage unit 150 may be implemented in various types of storage devices capable of inputting/outputting information such as an HDD (Hard Disk Drive), ROM (Read Only Memory), RAM (Random Access Memory), EEPROM (Electrically Erasable and Programmable Read Only Memory), flash memory, Compact Flash (CF) card, Secure Digital (SD) card, Smart Media (SM) card, MMC (Multimedia) card, Memory Stick, or the like, as is known to those skilled in the art, and may be provided inside the simulation apparatus 100 as shown in FIG. 3 or may be provided in a separate apparatus.

In addition, the simulation apparatus 100 or CBS module as shown in FIG. 3 may be provided as capacity bucket planning in the form of a site package, so as to be applied as a master planning (MP) system or factory planning (FP) system.

Using the block diagram of the simulation apparatus 100 shown in FIG. 3, a method for resource planning in a factory based on simulations, S400, shown in FIG. 4 will be described in greater detail.

First, the modeling unit 130 may model factory resources as capacity buckets in S410. Here, the factory resources may include a plurality of BucketSteps, each of which consists of a plurality of machines, and the modeling factory resources as capacity buckets S410 may include modeling each of the plurality of machines as the capacity bucket S411.

Once the modeling factory resources as capacity buckets is completed in S410, the demand allocation unit 140 may allocate a plurality of demands to the modeled capacity buckets in S420. Here, the plurality of demands may be prioritized according to predetermined priority rules, and the allocating a plurality of demands to the modeled capacity buckets S420 may include allocating the plurality of demands to the modeled capacity buckets based on the plurality of prioritized demands S421.

Moreover, in accordance with a further embodiment of the present invention, a plurality of machines included in each BucketStep may be further prioritized in allocating the plurality of demands to the modeled capacity buckets, and priority rules here may be based on, for example, factory environments, constraints, qualities, setups, and the like. Therefore, the allocating a plurality of demands to the modeled capacity buckets S420 may further include allocating the plurality of demands to the modeled capacity buckets based further on the plurality of prioritized machines S422.

In addition, for each of the plurality of demands in accordance with an embodiment of the present invention, a single demand may be considered as a single batch as shown in (a) of FIG. 1C or a single demand may be considered as a plurality of batches as shown in (b) of FIG. 1C, and in the latter case, the allocating a plurality of demands S420 in accordance with an embodiment of the present invention may further include dividing each of the plurality of demands into one or more batches and allocating the one or more divided batches to the modeled capacity buckets S423.

The modeling factory resources S410 and the allocating a plurality of demands S420 constitute a capacity bucket simulation (CBS) in accordance with the present invention, and the control unit 110 may construct factory resource planning by repeating the demand allocation in a bucket rolling period (BRP) for a predetermined time interval. To this end, the control unit 110 may determine whether the allocating has all been completed for a predetermined time interval (e.g., 30 days, 60 days, etc.) in S430, and as a result of the determination, if the allocating has been completed, the constructed factory resource planning is confirmed, and as a result of the determination, if the allocating has not been completed yet, the control unit 110 may control to repeat allocating to a next time bucket in S440.

Here, the control unit 110 may control the capacity bucket simulation (CBS) to be performed in the bucket rolling period (BRP), and the bucket rolling period (BRP) here may be, for example, 1 day as described above. For reference, although it is preferred to set the bucket rolling period (BRP) for the capacity bucket simulation to correspond to the time unit of the capacity bucket, the bucket rolling period does not necessarily have to match the time unit of the capacity bucket.

For reference, the capacity bucket simulation controlled by the control unit 110 may be based on discrete event simulations (DESs), and running simulations for each and every discrete event that occurs on a large number of machines in a factory not only consumes a lot of time in the simulations but also brings about very inefficient results. Thus, the control unit 110 in accordance with an embodiment of the present invention may be configured to control the modeling unit 130 and/or demand allocation unit 140 to perform simulations in a predetermined bucket rolling period (BRP), and the bucket rolling period (BRP) may be set to 1 day, for example, as described above and therefore, events within the bucket interval may be omitted.

For reference, the capacity bucket simulation (CBS) may be performed as a virtual simulation by compressing time units, for example, by compressing actual time of 1 day to 1 to 2 seconds, and thus, simulation results for task periods of 30 days, 60 days, etc. can be quickly obtained.

Here, in performing a simulation in each time bucket interval, the control unit 110 may determine whether the requirements of the plurality of demands are met, and as a result of the determination, if the requirements of all of the demands are met, it will proceed to the next time bucket interval, and as a result of the determination, if there exist demands whose requirements are not met, the priorities of such demands may be adjusted and the demand allocation unit 140 may be controlled to repeat the allocating a plurality of demands S420 according to new priority rules in which the adjusted priorities are reflected.

As described above, according to the method and apparatus for resource planning in a factory based on simulations in accordance with an embodiment of the present invention, it is possible to implement efficient resource planning to meet a plurality of demands by utilizing limited resources in the factory.

In addition, according to the method and apparatus for resource planning in a factory based on simulations in accordance with an embodiment of the present invention, it is possible to take into account time-specific constraints of resources and accordingly, to enable more efficient and accurate resource planning.

Moreover, according to the method and apparatus for resource planning in a factory based on simulations in accordance with an embodiment of the present invention, it is possible to enable more efficient and accurate resource planning by constructing the resource planning at the levels of machines provided in a BucketStep of performing the same process.

Furthermore, according to the method and apparatus for resource planning in a factory based on simulations in accordance with an embodiment of the present invention, it is possible to enable all the possible demands to be met more efficiently by constructing the resource planning based on the priorities for a plurality of demands and/or priorities for a plurality of machines in a BucketStep.

Moreover, according to the method and apparatus for resource planning in a factory based on simulations in accordance with an embodiment of the present invention, it is possible to maximize the operational efficiency of the factory and customer satisfaction, by allowing the priorities for a plurality of demands and/or priorities for a plurality of machines in a BucketStep to be variably adjusted according to a process or time.

Meanwhile, various embodiments described herein may be implemented by hardware, middleware, microcode, software, and/or combinations thereof. For example, various embodiments may be implemented in one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions presented herein, or combinations thereof.

Further, for example, various embodiments may be recorded or encoded on a computer-readable medium including instructions. Instructions recorded or encoded on the computer-readable medium may cause a programmable processor or other processors to perform a method, for example, when the instructions are executed. The computer-readable medium may include computer storage media, which may be any available media that can be accessed by a computer. For example, such a computer-readable medium may include RAM, ROM, EEPROM, CD-ROM or other optical disk storage medium, magnetic disk storage medium or other magnetic storage device.

Such hardware, software, firmware, and the like may be implemented in the same device or in separate devices so as to support various operations and functions described herein. In addition, the elements, units, modules, components, etc. described as “˜unit” in the present invention may be implemented together, or individually as logic devices that are separate but interoperable. The depiction of different features for the modules, units, etc. are intended to highlight different functional embodiments, and does not necessarily mean that these must be realized by individual hardware or software components. Rather, the functionality associated with one or more modules or units may be performed by separate hardware or software components or may be incorporated into common or separate hardware or software components.

Although the operations are illustrated in the drawings in a particular order, it should not be understood that these operations must be performed in the particular order illustrated or in a sequential order, or that all the operations illustrated need to be performed to achieve the desired results. In some environment, multitasking and parallel processing may be advantageous. Moreover, the division of various components in the embodiments described above should not be understood as requiring such division in all embodiments, and it should be understood that the components described may generally be incorporated together into a single software product or packaged into multiple software products.

As described above, preferred embodiments have been disclosed in the drawings and the description. Although specific terms have been used herein, these are used merely for the purpose of illustrating the present invention and not for limiting the meaning thereof or the scope of the present invention as defined in the claims. Thus, those having ordinary skill in the art will appreciate that various modifications and other equivalent embodiments are possible therefrom. Therefore, the true technical protection scope of the present invention should be defined by the spirit of the appended claims.

### REFERENCE NUMERALS AND SYMBOLS

100: Simulation apparatus
110: Control unit
120: Communication unit
130: Modeling unit
140: Demand allocation unit
150: Storage unit

What is claimed is:

1. A method for resource planning in a factory based on simulations, comprising:
modeling factory resources as capacity buckets;
allocating a plurality of demands to the modeled capacity buckets; and,
constructing factory resource planning by repeating the allocating in a bucket rolling period (BRP) for a predetermined time interval.

2. The method for resource planning in a factory based on simulations of claim 1, wherein the factory resources comprise a plurality of BucketSteps, each of which consists of a plurality of machines, and
the modeling factory resources as capacity buckets comprises modeling each of the plurality of machines as the capacity bucket.

3. The method for resource planning in a factory based on simulations of claim 2, wherein the allocating a plurality of demands to the modeled capacity buckets comprises prioritizing the plurality of demands according to predetermined priority rules, and allocating the plurality of demands to the modeled capacity buckets based on the plurality of prioritized demands.

4. The method for resource planning in a factory based on simulations of claim 3, further comprising:
prioritizing the plurality of machines included in each BucketStep,
wherein the allocating a plurality of demands to the modeled capacity buckets comprises allocating the plurality of demands to the modeled capacity buckets based further on the plurality of prioritized machines.

5. The method for resource planning in a factory based on simulations of claim 1, wherein the allocating a plurality of demands to the modeled capacity buckets comprises:
dividing each of the plurality of demands into one or more batches; and
allocating the one or more divided batches to the modeled capacity buckets.

6. The method for resource planning in a factory based on simulations of claim 1, wherein the bucket rolling period (BRP) corresponds to a time unit of the capacity bucket.

7. The method for resource planning in a factory based on simulations of claim 3, further comprising:
determining whether there exist demands whose delivery deadline requirement is not met among the plurality of demands;
if there exists at least one demand whose delivery deadline requirement is not met as a result of the determination, adjusting a priority for that demand; and
allocating the plurality of demands based on new priority rules in which the adjusted priority is reflected.

8. A simulation apparatus for constructing resource planning in a factory based on simulations, comprising:
a modeling unit for modeling factory resources as capacity buckets;
a demand allocation unit for allocating a plurality of demands to the modeled capacity buckets; and,
a control unit for constructing factory resource planning by repeating the allocating in a bucket rolling period (BRP) for a predetermined time interval.

9. A computer readable recording medium, having recorded thereon a program configured to perform the method according to claim 1 by a computer.
